(19) United States
(12) Patent Application Publication
(10) Pub. No.: US 2011/0109562 A1
(43) Pub. Date: May 12, 2011

(54) DECORATING FRAME OF TOUCH PANEL

(76) Inventor: Teh-Zheng Lin, Taoyuan (TW)

(21) Appl. No.: 12/616,119

(22) Filed: Nov. 10, 2009

(51) Int. Cl. G06F 3/041

(52) U.S. Cl. 345/173

(57) ABSTRACT

A decorating frame is formed to a touch panel having a touch sensing unit arranged insulated between a flexible top plate and a substrate. The sensing signal is conducted to a signal processing circuit through conducting wires arranged to edges of the touch sensing unit. The top plate, substrate, and touch sensing unit are transparent thin films. An opaque color frame formed to a peripheral of an upper surface of the top plate covers the conducting wires of the touch sensing unit. The color frame is made of organic or inorganic material by means of printing, to coating, or metal evaporating. The color frame can be also formed to a thin film substrate, and the thin film substrate is attached to the upper surface of the top plate.

### FIELD OF THE PRESENT INVENTION

The present invention relates to frame of a touch panel, and particular to a decorating frame formed to a top surface of the touch panel for sheltering and prettifying conducting wires arranged to edges of the touch panel.

### DESCRIPTION OF THE PRIOR ART

Touch panels nowadays are widely applied to consuming electronics such as mobile phone, digital camera, and global positioning system (GPS) to improve operating efficiency and make the interface friendly. On these electronic devices, touch panels are arranged in front of the display for users to perform input so as to improve operating efficiency and make the interface friendly. Normally, a touch panel has a touch sensing unit arranged insulated between a top plate and a substrate. The sensing signal is conducted to a signal processing circuit through conducting wires arranged to edges of the touch sensing unit. Moreover, prior touch panel is fixed to a display by pressing a peripheral of the touch panel with a frame. Although the frame can also cover signal wires on edges of the touch panel so as to improve the appearance, many disadvantages happen such as uneven surface of panel and dust deposited in the gap between the panel and the frame. The dust will cause a hygienic concern and malfunction to conductivity of the touch panel because the fragile signal wires are easily damaged by pressing or moisture leaked. To avoid such problems, a color frame is arranged between the top plate and the substrate for ensure the flatness and protection of the conducting wires. Such color frame is normally thicker than 50 μm and over-gluing and bubble are easily happened to the junction of the plates so that an optic characteristic and appearance are damaged.

### SUMMARY OF THE PRESENT INVENTION

Accordingly, the primary object of the present invention is to provide a decorating frame to a touch panel by forming a color frame to a peripheral of an upper surface of a top plate so as to improve an appearance of the assembly, yield, and optical characteristic and also simplify the manufacturing process without having over-gluing or bubble issues.

To achieve above object, the decorating frame of the present invention is a color frame made of ink, color photo resistance, and organic material or inorganic material but not restricted within previous materials. The above materials are arranged to the periphery of the upper surface of the top plate by means of printing, coating, or metal evaporating but not restricted within above means.

The color frame can be an opaque or nearly opaque thin film made of organic material with a thickness below 35 μm.

The color frame can also be an opaque or nearly opaque thin film made of inorganic material with a thickness below 15 μm.

The color frame can be also formed to a thin film substrate, and the thin film substrate is attached to the upper surface of the top plate so that the color frame is arranged to the peripheral of the upper surface of the top plate. The thin film substrate is made of physical transparent material such as polycarbonate (PC), polyester (PET), polymethyl methacrylate (PMMA), Cyclo-Olefin Copolymers (COC) but not restricted within previous materials.

### BRIEF DESCRIPTION OF THE DRAWINGS

FIG. 1 is a schematic view of an embodiment of the present invention.

FIG. 2 is an exploded view of the embodiment of the present invention.

FIG. 3 is a cross-section view partially showing the embodiment of the present invention, and

FIG. 4 is a cross-section view partially showing another embodiment of the present invention.

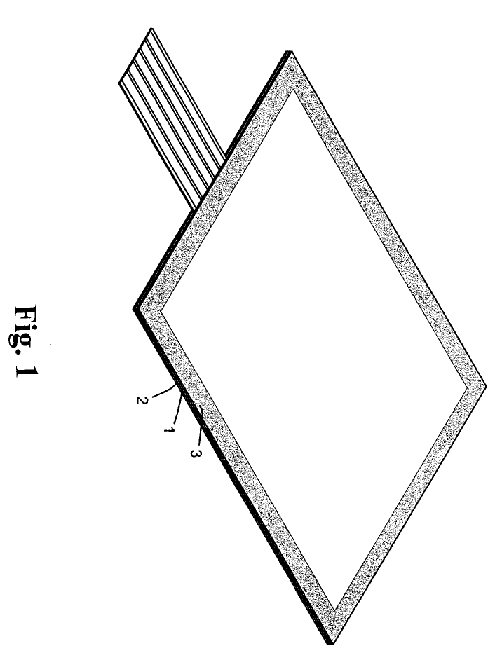

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

A resistive touch panel shown in the following Figures is used as an embodiment of the present invention. A resistive touch sensing unit 5 capable of sensing a pressing by a finger or a tip of a pen is arranged between a top plate 1 and a substrate 2. By sensing the voltage variance generated by the pressing on the touch sensing unit 5, the pressed position will be located.

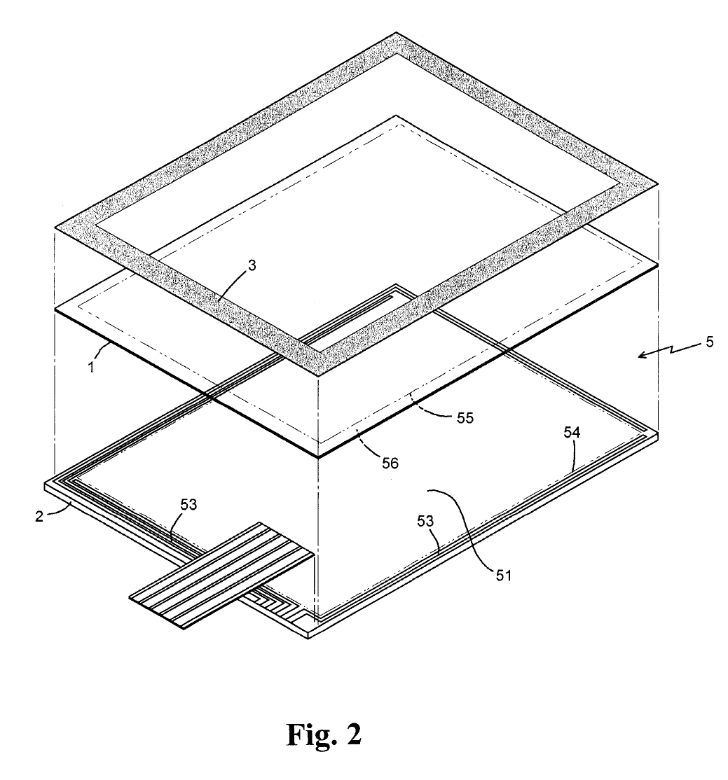

The substrate 2 is a transparent thin plate such as a thin glass plate. A lower resistive film 51 of the resistive touch sensing unit 5 is formed to an upper surface of the substrate 2. A plurality of protruding spacers 52 are uniformly distributed within the resistive film 51. Conducting wires 53 for sensing signal are formed to four edges of the resistive film 51. A closed gluing loop 54 is formed near the conducting wires 53 on the edges of the substrate 2 (an area outside the dotted line on the surface of the substrate 2 shown in FIG. 2). The top plate 1 can be a flexible film such as a polycarbonate (PC) film. An upper resistive film 55 is formed to a bottom surface the top plate 1. Conducting wires 56 for conducting the sensing signals are formed to edges of the resistive film 55. While assembling, the top plate 1 and the substrate 2 are attached by the gluing loop 54, and the upper and lower resistive films are arranged oppositely with a gap.

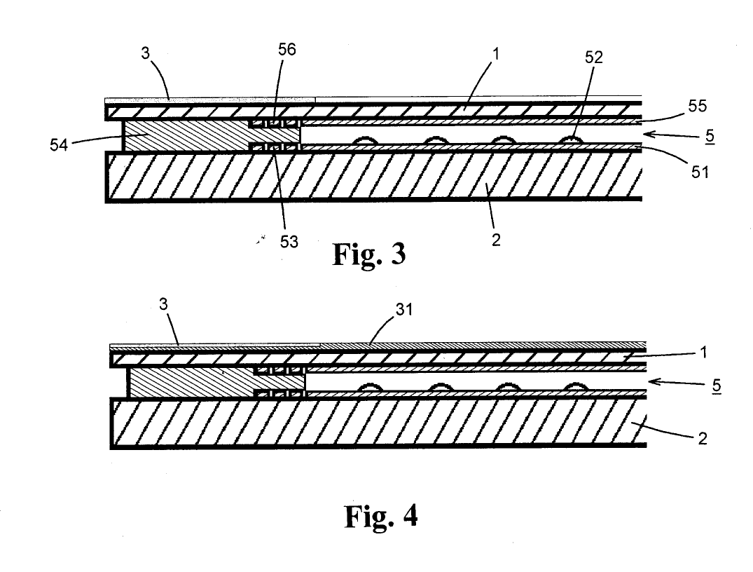

Moreover, a peripheral of an upper surface of the top plate 1 has a color frame 3. The color frame 3 will cover the conducting wires 53, 56 on the edges of the touch sensing unit so as to have a better appearance. As shown in FIG. 3, the color frame 3 is made of silver or inorganic material by means of metal evaporating so as to form an opaque or nearly opaque thin film with a thickness below 15 μm. The color frame 3 can be also made of ink, color photo resistance, and organic material by means of printing or coating so as to form a color frame with a thickness below 35 μm. As shown in FIG. 4, the color frame 3 is formed to a thin film substrate 31. The thin film substrate 31 is attached to the upper surface of the top plate 1 so that the color frame 3 will cover exactly upon the conducting wires 53 and 56 of the touch sensing unit.

Comparing the touch panel assembly assembled by above components with prior touch panel, the color frame 3 is directly formed onto the peripheral of the upper surface of the top plate 1 so as to prevent disadvantages of over-gluing or bubble on the edges of the panel. Also, a yield, an optical characteristic and a surface flatness of product is improved.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A decorating frame formed to a touch panel; the decorating frame having a touch sensing unit being insulatedly arranged between a flexible top plate and a substrate; sensing signals being conducted to a signal processing circuit through conducting wires arranged to edges of the touch sensing unit; the top plate, substrate, and touch sensing unit being transparent thin films; an opaque color frame formed to a peripheral of a top surface of the top plate being capable of covering the conducting wires of the touch sensing unit.

2. The decorating frame as claimed in claim 1, wherein the color frame is an opaque thin film made of inorganic material with a thickness under 15 μm.

3. The decorating frame as claimed in claim 1, wherein the color frame is an opaque thin film made of organic material with a thickness under 35 μm.

4. The decorating frame as claimed in claim 1, wherein the color frame is formed to a thin film substrate which can be attached to the upper surface of the top plate.
